(19) United States
(12) Patent Application Publication
(10) Pub. No.: US 2004/0088215 A1
(43) Pub. Date: May 6, 2004

(54) Methods and systems for award document generation and approval

(76) Inventors: Sallie Jean Rochelle, Hampstead, NC (US); Ronny Leu, San Jose, CA (US); James A. Robinson JR., Rocky Point, NC (US); Louis Sterio JR., San Jose, CA (US)

Correspondence Address: John S. Beulick, Armstrong Teasdale LLP, Suite 2600, One Metropolitan Sq., St. Louis, MO, 63102, US

(21) Appl. No.: 10/284,532

(22) Filed: Oct. 30, 2002

(51) Int. Cl. G06F 17/60

(52) U.S. Cl. 705/14; 705/11

(57) ABSTRACT

An employee awards system is provided. In an examplary embodiment, the awards system includes a database having a plurality of active server pages stored therein. The active server pages include at least an awards request form. The awards request form includes a field for entry of a reason for an employee award and a recommended award amount. The system further includes a server coupled to the database. The server is programmed to process data and selections made via the active server pages. The server is further programmed to generate at least two e-mails upon submission of the awards request form. A first of the e-mails generated is directed to a nominator of an award and a second of the e-mails generated is directed to a manager of a nominee of an award.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

At least some businesses utilize employee recognition awards to reward an employee for an outstanding result or other achievement. Such awards include, for example, gift certificates for dinner at a local restaurant, or a monetary award to recognize achievement of a particularly important business goal. Such awards can boost employee morale as well as emphasize the importance of certain employee behavior/achievements. If such awards are granted on an inconsistent basis, or after a long delay after accomplishment of a particular achievement, the recognition can be less than fully effective at boosting morale or encouraging certain employee behavior.

Particularly in businesses having hundreds, thousands, or possibly even hundreds of thousands of employees, simply managing such awards can be time consuming and difficult. For example, multiple approvals may be required prior to granting a reward. As one example, for a “gift certificate” award, a request is submitted to the employee's manager. Once approved by the employee's manager, the award request is forwarded to the next level manager for approval and then on to the responsible distributor for the gift certificate. After an administrator verifies that appropriate levels of approvals were obtained, a gift certificate is obtained and then returned to the manager requesting the award. The manager then delivers the gift certificate to the employee. Upon employee acceptance, the manager notifies the administrator, and the administrator manually enters the award monetary value into the payroll system resulting in a paycheck adjustment to account for the additional income to the receiving employee. A similar process can be utilized for monetary awards, which covers award types such as merit, attendance, and patent awards.

In addition to the time and difficulty involved in managing an award system in one business as explained above, in a company composed of many different businesses, each business may employ a different process for awarding employees. In addition, the type or extent of an award in one business may differ from the type or extent of an award in another business. These differences may be due, for example, to the different nature of each business. These differences, however, may add to the complexity and time required for managing the employee recognition system.

Reducing the processing time for approving and making such rewards supports higher employee morale as well as productivity increases for those associated with the award process. Further, and to encourage employee recognition awards, a recognition system should be user friendly and secure. Also, since multiple approvals typically are required prior to making an award, such system should provide reliable execution of multi-level processes to deliver the desired employee recognition. Such a system should also ensure appropriate levels of authorizations/nominations, specific dollar level approvals, consistency in payments and integration with payroll processing systems.

### BRIEF SUMMARY OF THE INVENTION

In one aspect, an employee awards system is provided. In an example embodiment, the awards system includes a database having a plurality of active server pages stored therein. The active server pages include at least an awards request form. The awards request form includes a field for entry of a reason for an employee award and a recommended award amount. The system further includes a server coupled to the database. The server is programmed to process data and selections made via the active server pages. The server is further programmed to generate at least two e-mails upon submission of the awards request form. A first of the e-mails generated is directed to a nominator of an award and a second of the e-mails generated is directed to a manager of a nominee of an award.

In another aspect, a method for operating a computer to nominate a person for an award is provided. The computer is programmed to display a plurality of active server pages. The method includes the steps of operating the computer to display a plurality of active server pages, at least one of the active server pages including an awards request form. The awards request form includes a field for entry of a reason for an employee award and a recommended award amount. The method further includes operating the computer to process data and selections made via the active server pages. The processing includes generating at least two e-mails upon submission of the awards request form. A first of the e-mails generated being directed to a nominator of an award and a second of the e-mails generated being directed to a manager of a nominee of an award.

### BRIEF DESCRIPTION OF THE DRAWINGS

FIG. 1 is block diagram of one embodiment of an employee award system.

FIG. 2 is a block diagram of another embodiment of an employee award system.

FIG. 3 is an example screen shot of a link to the employee award system.

FIG. 4 is an example screen shot of an award request form.

FIG. 5 is an example screen shot of an e-mail sent to the user after submitting a nomination.

FIG. 6 is an example screen shot of an e-mail sent to a manager responsible for authorizing a recommended award.

FIG. 7 is an example screen shot of a listing of award types and values.

FIG. 8 is an example screen shot of a listing of administrators.

FIG. 9 is an example screen shot of an example e-mail sent to the approving manager.

FIG. 10 is an example screen shot providing an administrator with notice of an award pick up.

FIG. 11 is an example screen shot of an e-mail sent to a nominee.

FIG. 12 is an example screen shot of an e-mail sent to a nominee.

FIG. 13 is an example screen shot of an award request approval form.

FIG. 14 is an example screen shot of an awards history.

FIG. 15 is an example screen shot of an e-mail to the manager that approved the award.

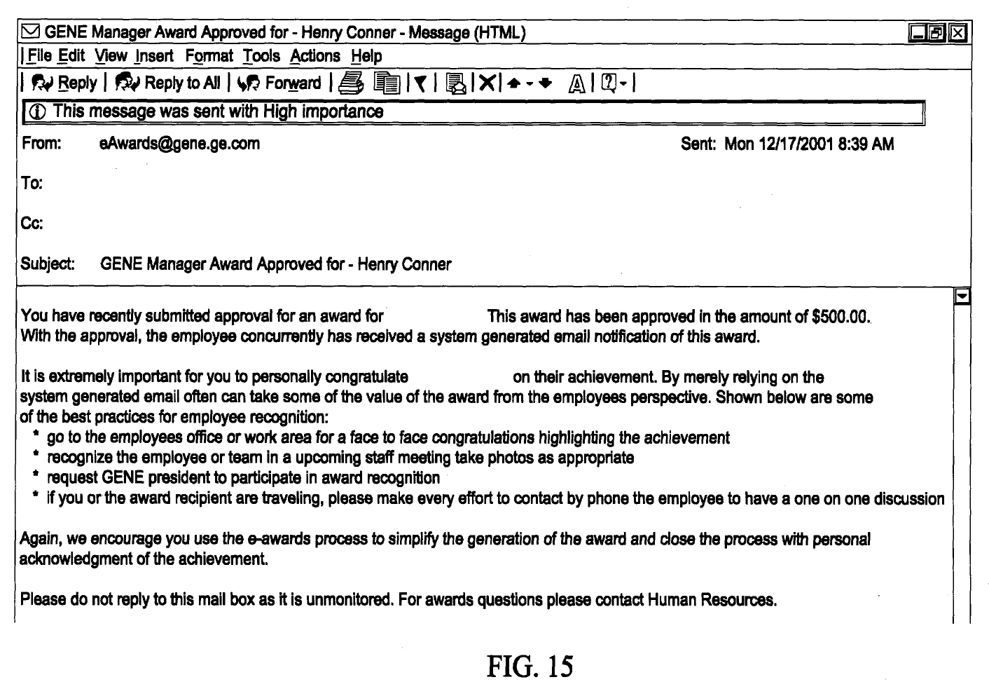

FIG. 16 is an example screen shot of an e-mail sent to the nominee.

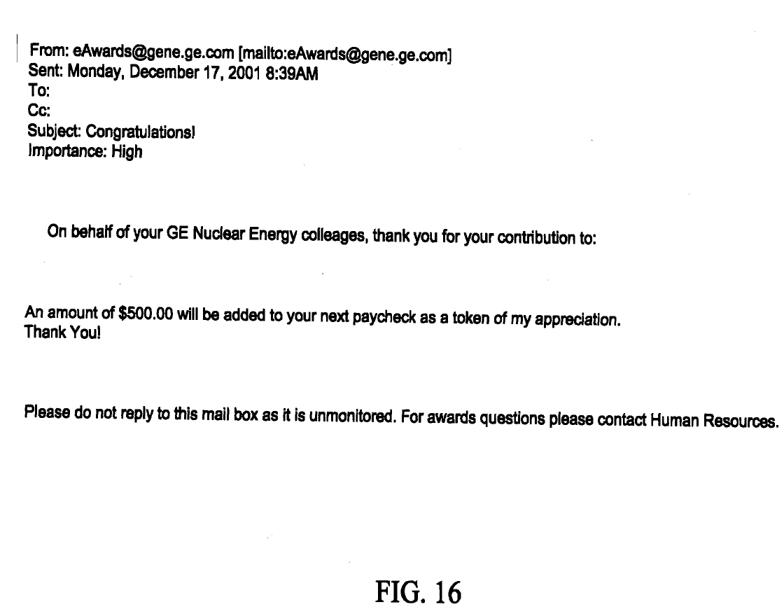

FIG. 17 is an example screen shot of an administrator login page.

FIG. 18 is an example screen shot of an administrators initial page after logging into the system.

FIG. 19 is an example screen shot of a listing of awards waiting for pickup.

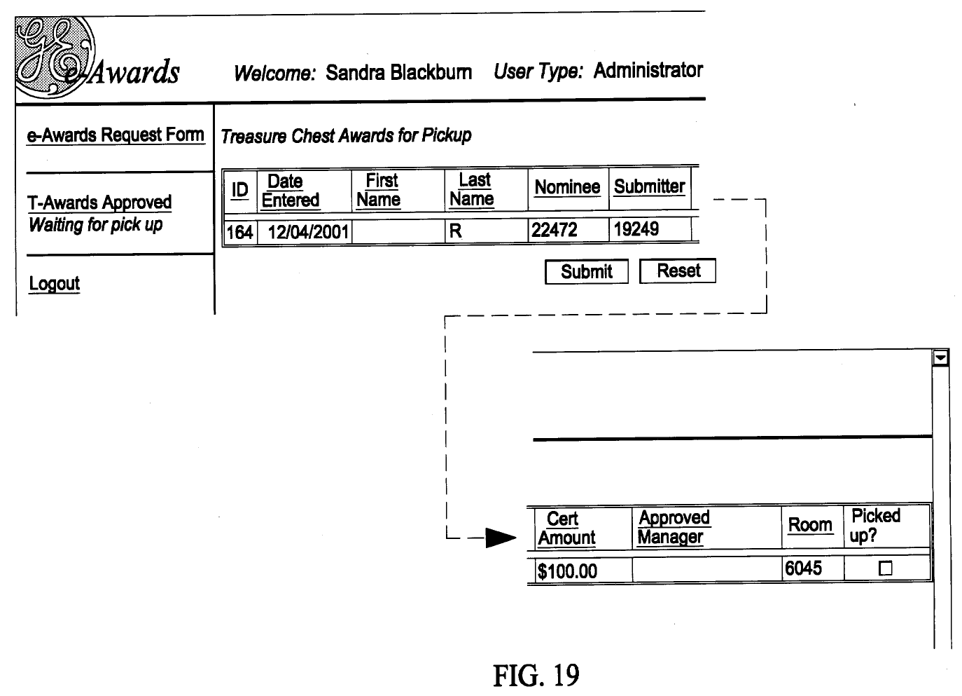

FIG. 20 is an example screen shot of an e-mail sent to a nominee.

FIG. 21 is an example screen shot of an administrator/manager login.

FIG. 22 is an example screen shot of a manager initial page after logging into the system.

FIG. 23 is an example screen shot of a top administrator initial page after logging into the system.

### DETAILED DESCRIPTION OF THE INVENTION

Exemplary embodiments of methods and systems for generating documentation relating to employee awards, as well as for securing approvals and managing such award programs, are described below in detail. The methods and systems, however, are not limited to the specific embodiments described herein. In addition, components of each system and steps of each process can be practiced independent and separate from the systems and methods described herein, and can be used in combination with other systems and methods.

Generally, the methods and systems described below facilitate speeding the process for granting employee awards, which supports higher employee morale as well as productivity increases for those individuals associated with the award process. In one aspect, the system includes a network server coupled to a database having a plurality of active server pages (ASP) stored therein. A user makes selections and supplies information to the server via the ASPs, and the server then executes algorithms based on the user selections and supplied information.

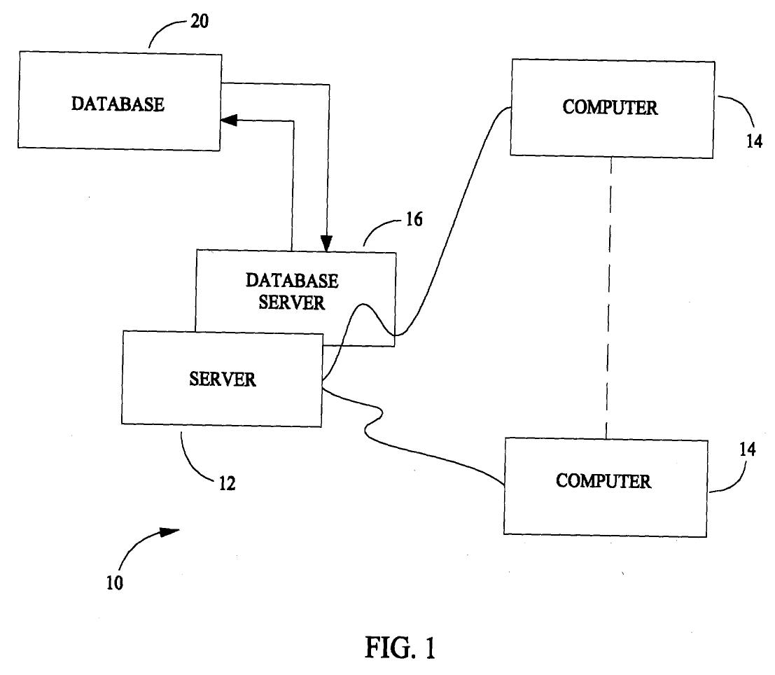

Referring more particularly to the drawings, FIG. 1 is a simplified block diagram of an employee awards system 10 that includes a server 12, and a plurality of client sub-systems, also referred to as clients 14, connected to server 12. In one embodiment, clients 14 are computers including web browsers, such that server 12 is accessible to clients 14 via a local area network (e.g., an intranet) or wide area network (e.g., internet). Clients 14 can be connected to such networks through many interfaces such as through dial-in-connections, cable modems and special high-speed ISDN lines. Clients 14 can be any device capable of interconnecting to the networks including a web-based phone, personal digital assistant (PDA), or other web-based connectable equipment. A database server 16 is in communication with a database 20 containing information, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

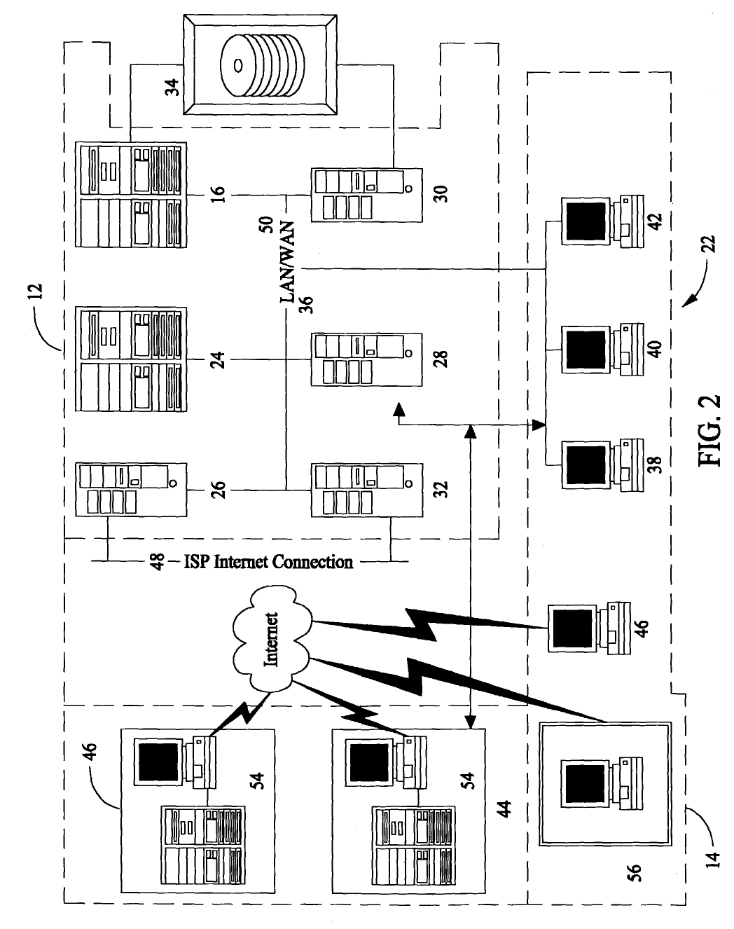

FIG. 2 is an expanded version block diagram of an exemplary embodiment of a server architecture of an employee awards system 22. Components in system 22, identical to components of system 10 (shown in FIG. 1), are identified in FIG. 2 using the same reference numerals as used in FIG. 1. System 22 includes a server subsystem 12 and clients 14. Server sub-system 12 includes database server 16, an application server 24, a web server 26, a fax server 28, a directory server 30, and a mail server 32. A disk storage unit 34 is in communication with database server 16 and directory server 30. Servers 16, 24, 26, 28, 30, and 32 are coupled in a local area network (LAN) 36. In addition, a system administrator's workstation 38, a user workstation 40, and a supervisor's workstation 42 are in communication with LAN 36. Alternatively, workstations 38, 40, and 42 are in communication with LAN 36 via an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at any one of many personal computers in communication with LAN 36. Work stations 38, 40, and 42 are illustrated as being associated with separate functions only to facilitate an understanding of the different types of functions that can be performed by individuals having access to LAN 36.

Server system 12 is configured to be in communication with various individual workstations, including users at a remote user workstation 44 and administrators at a remote administrator's workstation 46, via an ISP Internet connection 48. The communication in the exemplary embodiment is illustrated as being performed via the Internet, however, any other wide area network (WAN) 50 type communication can be utilized in other embodiments, i.e., the systems and methods are not limited to being practiced via the Internet. In addition, and rather than WAN 50, local area network 36 could be used in place of WAN 50.

In the exemplary embodiment, any authorized individual or business-entity having a workstation 54 can access system 22. One of the client systems includes a manager's workstation 56 located at a remote location. Work stations 54 and 56 are personal computers having a web browser. Also, work stations 54 and 56 are configured to communicate with server system 12.

In one specific example, the employee award system includes a plurality of active server pages (ASPs). The ASPs are stored in a database (e.g., database 20 in the embodiment illustrated in FIG. 1). As is well known, information input into an ASP, as well as selections made via an ASP, are used by the server to execute certain processes, or algorithms. Set forth below is one specific example of a system, along with a description of server performed processes, employing ASPs.

More specifically, and in one example embodiment, the ASPs include header (Header.asp), navigation (Nav.asp), a default (Default.asp), select case (Selectcase.asp) and footer (Footer.asp) pages. Information is stored in tables. Some of the tables are embedded within other tables. The system includes one main table that begins in the Header.asp page and ends in the Footer.asp page. A listing of ASPs in the one specific embodiment is set forth below.

act_mawards_declined.asp

act_mawards_history.asp

act_pending_pickup.asp

act_tawards_history.asp

add_tc_admin.asp

add_top_admin.asp

annual_report.asp

awards_pending.asp

band.asp

clock.asp

create_dexcel.asp

create_mexcel.asp

create_texcel.asp

current_nom.asp

default.asp

docket_report.asp

execute_form.asp

execute_hr_mgr_form.asp

execute_mgr_form.asp

execute_ohr_mgr_form.asp

footer.asp

get_login.asp

get_payno.asp

get_payno2.asp

header.asp

hr_mgr_form.asp

login.asp

logout.asp

mawards_declined.asp

mawards_history.asp

mgr_form.asp

nav.asp

new_pass.asp

ohr_mgr_form.asp

payno.asp

payno2.asp

pending_pickup.asp

request_form.asp

selectcase.asp

tawards_history.asp

welcome.asp

welcome2.asp

The Header.asp page provides various functions including establishing a connection with the database, e.g., an Oracle database, a “sortby” function which is used to sort displayed data in the history tables, a javascript box used to display the awards history of an individual in the forms, and display of the user and user type when a manager or admin has logged in.

The Nav.asp page shows the function capability of each user type when logged in. If the user is not logged in, the default selections available is shown. The default selections include Request Form, Manager/Admin Login, and Home. The Nav.asp page functionality includes lop admin (full access capability), manager (able to approve only the awards request directed towards that manager), dept-manager (able to approve the awards requests directed towards that manager) and administrator (able to access the pending pickup table according to awards to that treasure chest administrator's location).

The Footer.asp page is where the table created in the header page ends. The footer contains the current date, current time, and the year, which changes dynamically according to system year.

The Default.asp page is the main page where the header, footer, and select pages are connected together. The default page also displays all the other pages according to Selectcase.asp

The Selectcase.asp page is the core of where pages are directed. The Selectcase.asp page stores the cases of each page and directs the user to the selected page. The selectcase.asp page also allows the creator to set sessions so that if the user is not logged in, the user cannot access any of the pages under the selectcase.asp page.

With regard to pay numbers, and in the specific embodiment, the pay number of the submitter and the nominee is obtained. Two pages are used to obtain such information. Specifically, the Payno.asp page has two text boxes that require the user to fill. These two boxes are:

Submitter NE/NEV ID

Nominee NE/NEV ID

The Get_payno.asp page retrieves the ids from Payno.asp and verifies if the numbers entered are valid. If the numbers are not valid, this page directs the user back to the Payno.asp page and displays the reason why the pay number was not accepted.

The Payno2.asp page is similar to the Payno.asp page and includes a Submit and Copy selection. The Getpayno2.asp is used to get the pay number, and it checks and verifies if a new nominee id is valid. Getpayno2.asp also checks to assure that a duplicate submittal is not being requested.

Forms are used to collect information relating to a particular award. The forms include a Request_form.asp page. This page is used at the initiation of the nomination process. From the Get_payno.asp page, company information of both the submitter and nominee (e.g., full name, social security number) is obtained according to their NE/NEV user ids. In the request_from page, the nominee can fill in the reason for the nomination.

The Execute_form.asp page is the backend page of Request_form.asp page. This page processes to see if any fields in the Request_form.asp page are blank. If the fields are completely filled, then an e-mail is sent to the nominee's department manager and to the submitter of the form, and the nomination is saved in the current nominations table to await manager approval.

The Mgr_form.asp page is an in depth form used in performing several functions. When the link is clicked in the email by the department manager, the manager is directed to this page. Similar to the Request_form.asp page, the nominee and submitter's information is already filled out. The reason field is also filled but the text inside cannot be edited by the manager. The other functions of this page are set forth below.

Selecting whether the award is Treasure Chest or Monetary.

1. If the award is Treasure Chest, a pre selected amount in denominations of 50 dollars is selected in a drop down box.

The manager also selects the administrator/location where the nominee can pick up the award.

2. If the award is Monetary, the manager selects the type of the award and the amount. This selection determines whether this award is gross or net (e.g., an aware of net $5,000 means that after taxes, the net award is $5,000), what type of award it will be and the amount.

Award History on the Nominee is viewable by a link in the bottom right hand corner.

In some cases if the pay band on nominee is higher than a predetermined level, the page is automatically directed to another page called Band.asp. In that page the manager may be informed that the nominee cannot receive a reward, however, an automatically generated e-mail may be sent to the nominee giving a congratulations.

The Execute_mgr_form.asp page is the backend of Mgr_form.asp page. There are also several functions in the backend page. This page checks whether any fields have been left blank in Mgr_form.asp page. If there are blanks, the manager is redirected back to Mgr_form.asp. If the manager declines the award, text will be displayed indicating that the award was declined. There is also an autmoated e-mail function in the Execute_mgr_form asp page. The e-mail function logic is set forth below. Of course, the amounts and types of awards are exemplary and other amounts and award types can be utilized in connection with defining automated e-mail generation and sending.

If it is a Treasure Chest award:

1. An email is sent to the department manager that approved the award.

2. An email is sent to the selected treasure chest administrator

3. An email is sent to the nominee receiving the award.

If the award is monetary and below $1000:

1. An email is sent to the department manager that approved the award.

2. An email is sent to the nominee receiving the award.

If the award is monetary and between $1000 and $2999:

1. An email is sent to the department manager that approved the award.

2. An email is sent with a link to the general-manager for approval.

If the award is monetary and between $3000 and $3999:

1. An email is sent to the department manager that approved the award.

2. An email is sent with a link to the head of human relations for approval.

If the award is monetary and is over $4000:

1. An email is sent to back to the head of human relations.

2. An email is sent with a link to the manager of the entire business for approval.

The HR_mgr_form.asp page is identical to the Mgr_form.asp page, except that there is no option to select type of award and all blanks including award type have already been filled out. The human relations (hr) manager can access the amount, e.g., keep the amount the same or change the amount.

The Execute_HR_mgr_form.asp page is the backend of HR_mgr_form.asp. This page is very similar to Execute_mgr_form.asp. If the manager declines the award, text will be displayed explaining that the award was declined. Logic for automated generation of e-mails from this page is below.

If the award is approved and amount is not changed:

1. An email is sent to the manager that approved the award.

2. An email is sent to the nominee receiving the award.

If the award is approved and amount is changed:

1. An email is sent to the manager that approved the award.

2. An email is sent to the department manager notifying the department manager of the change.

3. An email is sent to the nominee receiving the award.

The OHR_mgr_form.asp page is identical to the HR_mgr_form.asp page. This page is used by the manager of the overall business to approve awards greater that 4000.

The Execute_OHR_mgr_form.asp page is the backend of OHR_mgr_form.asp page. This page is functionality is the same as the Execute_HR_mgr_form.asp page. If the manager declines the award, text will be displayed explaining that the award was declined. Logic for the automated generation of e-mails from this page is set forth below.

If the award is approved and amount is not changed

1. An email is sent to the GENE manager that approved the award.

2. An email is sent to the nominee receiving the award.

With respect to logging into the system, there are three types of user logins, namely, administrator, top administrator, and manager login. Administrator, top administrator, and manager logins are retrieved from different tables, but all use the same logon screen. Administrators and top administrators can use their Payno as their login and their social security number as their password, and managers use their human relations identifier as their login and their own unique password. If a manager has not selected a password, the password is automatically set to their human relations identifier.

The Login.asp page has two text boxes that the user completes. These two boxes are the Login and Password. The Get_login.asp page takes the login information from the Login.asp page and checks the entered information with tables to determine the user type (admin, top admin, or manager) and sets a session based on the determined user type. If the user is a manager but has not changed their default password to a new password, the user will automatically redirected to the New_pass.asp page where a new password can be inputted.

There are two types of pending awards. The first approval is the department manager, which is in charge of the Treasure chest and monetary awards under $1000, the second approval is the general manager level, which is in charge of monetary awards above $1000. The department manager can access the pending awards page through the email link or the function named Current Nominations, in the navigation bar. The general manager can access the pending awards through the email link or the function named M-Awards Pending, in the navigation bar. There is also a function called Pending Pickup, which is used for administrators to move Treasure chest awards that have already been pickup into Treasure chest history and to write to the payroll file to update the employee record.

The Current_nom.asp page displays, in a table format, all the awards left that still need to be approved by the department managers. Only the nominations which the current manager logged in is in charge of completing will be displayed. Links provided for each award nomination that will bring the page to the Mgr_form.asp page, which will be filled out according to the award data for the link.

The Awards_pending.asp page is identical to the Current_nom.asp page, except that awards pending are greater than $1000 and need the general manger level manager to complete the awards. As with the Current_nom.asp page, only the pending awards that require the current logged in manager to approve are displayed.

The Pending_pickup.asp page displays all the treasure chest awards that need to be picked up. However, the current admin logged in can only see their own awards left to be given out. When the award is picked up, the treasure chest admin can check the Picked-up option next to award to complete the process.

The Act_pending_pickup.asp page, according to the boxes checked for picked up in Pending_pickup.asp, causes an e-mail to be sent out to all those who have picked up their award. This page also takes the data from the pending pickup table and moves it the Treasure Chest awards history table.

For searching, there are three search functions, namely a Monetary Awards History, a Treasure Chest History, and a Monetary Awards Declined. The Mawards_history.asp page provides six different ways to search.

1. Date

2. Submitter Payno

3. Nominee Payno

4. Amount

5. Award Code

6. Manager Last name

The Tawards_history.asp page provides four different ways to search.

1. Date

2. Submitter Payno

3. Nominee Payno

4. Certificate Amount

5. Manager Last name

The Mawards_declined.asp page provide five different ways to search.

1. Date

2. Submitter Payno

3. Nominee Payno

4. Amount

5. Award Code

6. Manager Last name

Each selection will either have text boxes that need to be typed in or a drop down box to pick a selection for search.

Act_mawards_history.asp

Act_tawards_histoy.asp

Act_mawards_declined.asp

From the search function used in each of the front end pages, the backend pages of each processes the search and displays it in a table for the user to view. This page also creates the option for the user to sort by any of the fields listed. There is also a button in the bottom of the pages to create an excel report with the data being displayed.

Create_mexcel.asp

Create_texcel.asp

Create_dexcel.asp

When the excel button is selected, the user is directed to another page according to what type of search the user created in the beginning. The excel report has a link to the generated file on the server. The user can then save the file to their own desktop for further use.

With respect to reports, there are three types of reports with each report having different pre-selected requirements. Specifically, the Annual_report.asp page shows the employees and their managers name who have not received an award for the current year. The Docket_report.asp page shows all the employees that received an award for a patent for the year. The Quarter1_report.asp page shows all the employees who have received three awards or more, or have received a total of more than $1,000 for the current quarter.

The are two pages for defining the functionality of controlling who is an administrator within the system. The Add_tc_admin.asp page allows the current top admins to be able to add treasure chest admins to the current list, and also allows them to be able to delete the current treasure chest admins. The Add_top_admin.asp page allows the current top admins to be able to add new top_admins tot he current list, and also allows them to delete the current top_admins.

With regard to other pages in the system, the Clock.asp page has the javascript for the dynamic clock which is in the bottom left hand corner of system. When a user selects the logout button, the user is directed to the Logout.asp page which displays a message to the user asking whether the user is sure s/he wants to log out. Logic executed based on the input supplied on the Logout.asp page is set forth below.

Yes—Redirects to the start up page and all session are cleared.

No—Redirects the user back a step.

The Welcome.asp page contains the text that is shown when the system is initiated and loaded. The Welcome2.asp page contains the text that is show when a manager or administrator logs into the system. The delete.asp page permits the top administrator to delete records from the table as necessary.

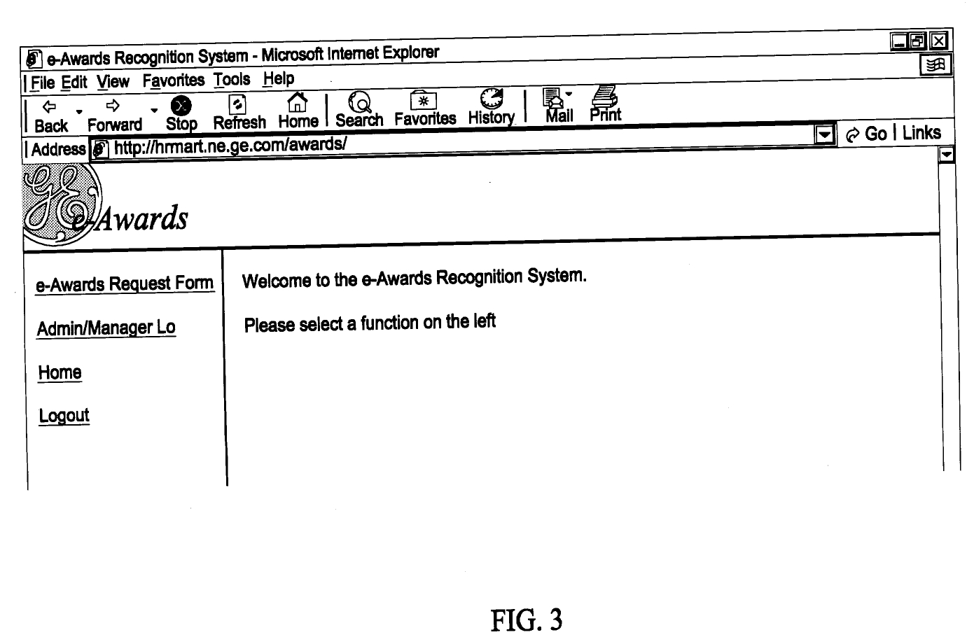

Set forth below is a description of specific embodiments of pages that can be displayed by the system. Of course, variations and modifications to such pages are possible, and the invention is not limited to practice in connection with the specific examples set forth below. More particularly, and referring to FIG. 3, the system is accessed, in the example embodiment, via an intranet. The system allows an employee to enter a nomination for another employee at any location. The system, in the example embodiment, does not accept entries by or for contract employees or terminated employees.

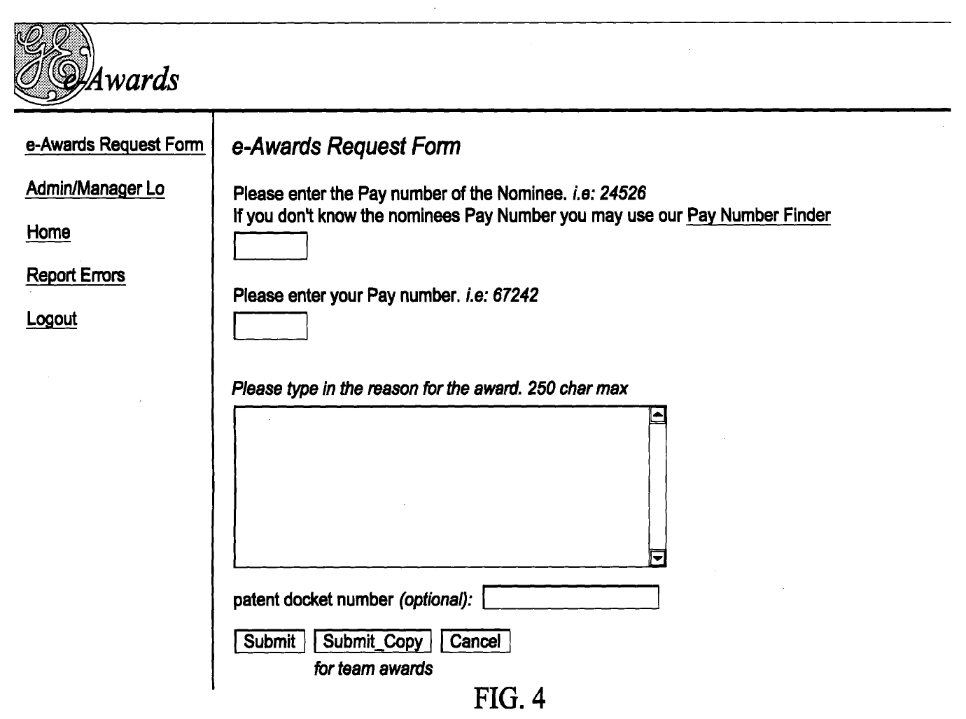

To initiate an award, the nominator selects from the side bar e-Awards Request Form. Once this selection is made the nomination screen appears as illustrated in FIG. 4. The nominator enters the payroll identification number for the employee they wish to nominate for an award followed by their own payroll identification number. The payroll identification number is comprised of 5 digits and can be found, for example, on an employee id badge. If the nominator cannot locate the employee pay number, the nominator can click on the pay number finder page to support a lookup of the employee information.

The nominator then reviews the Award Nominee Information to assure the correct payroll id was entered. Next, the nominator enters the reason for the award nomination. A clear description of the award nomination should be included in this field, including specific details regarding the accomplishment as well as a recommendation for an award amount. This field is used later in the process as part of the employee notification. If this nomination is regarding a patent submittal, the patent docket field should be completed. The nominator should also review the Submitter Pay Number to assure they are referenced here. If the award is for a team or multiple recipients, the user should select submit and copy. This action will request the nominator to input the next pay number to receive the award and return to the nomination screen shown above. Once the payroll id is entered, the previous reason data for the award will appear and will allow for editing as necessary. If it is an individual award or the last entry on the team award, the user selects the submit button to complete the transaction.

In the specific embodiment described above, if the nominee is exempt salaried with a band level above a predetermined band, then that employee cannot receive an award. When the nominator selects submit, the nominator will receive an automatically generated e-mail confirming the award nomination was successfully submitted, followed by another email notification to the nominee giving congratulations using the nominator's text. No further processing, however, will be performed.

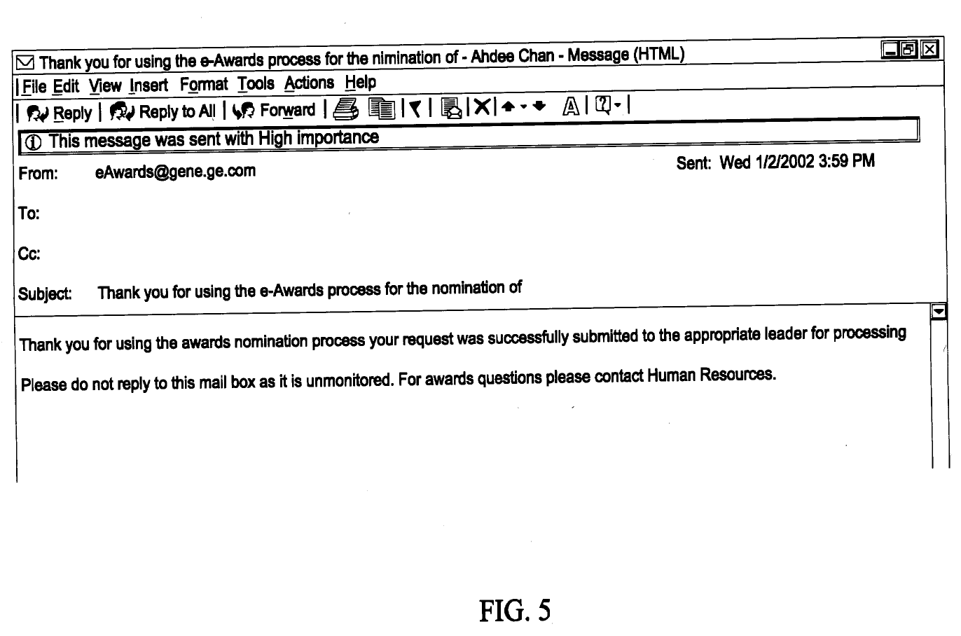

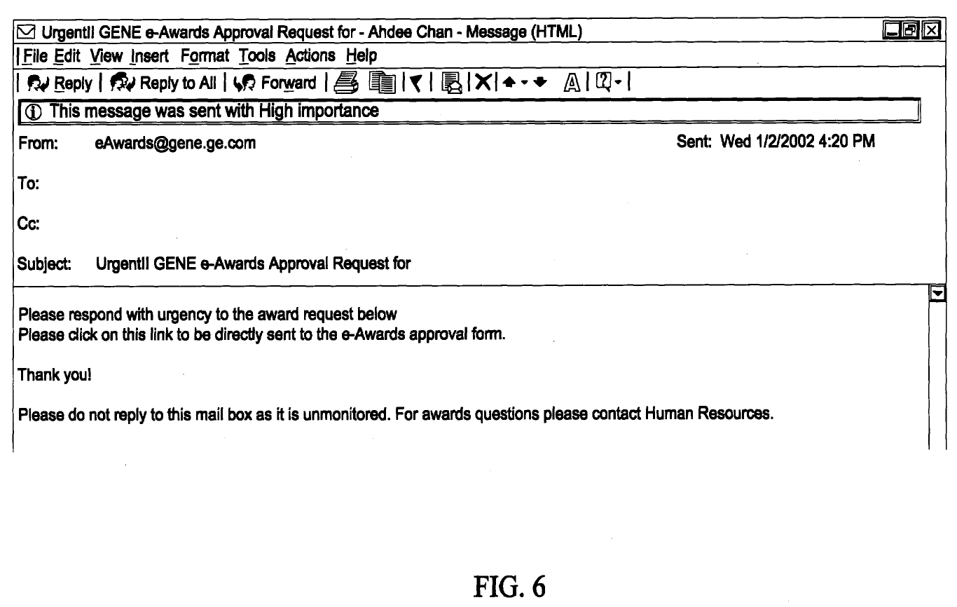

For award nominations that continue through the process, two emails are generated. One email, as shown in FIG. 5, is sent to the user's mailbox as shown below to confirm the award nomination has been successfully submitted. Another email, as shown in FIG. 6, is forwarded to the nominee's manager's mailbox identifying the need for response to the nomination. Within this email is a direct link to the award nomination page. The manager should respond to the message by selecting the blue hyperlink text in the message.

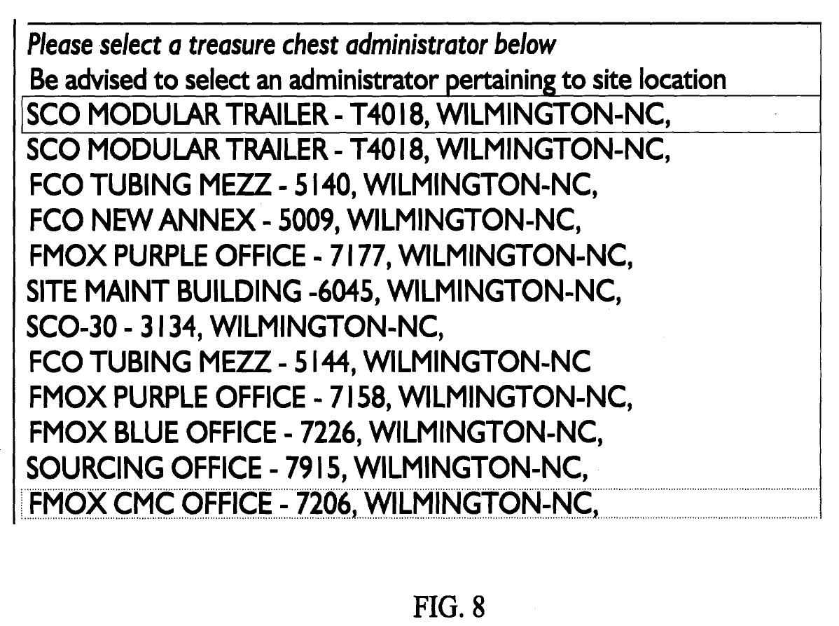

The manager can view the award nomination. As shown in FIG. 8, nominee information as well as the reason for the award are displayed to the manager. The manager can edit the reason for the award adding specific recognition appreciation wording as well as removing any recommendations for award amounts or erroneous data the nominator may have entered. The field, as edited by the manager, will later be emailed to the employee on a form of notification of the award receipt.

If the award is to be declined, the manager selects “Decline”, and the form is saved to a decline table for future reference. The manager also is instructed by a screen prompt to advise the nominator of the decline.

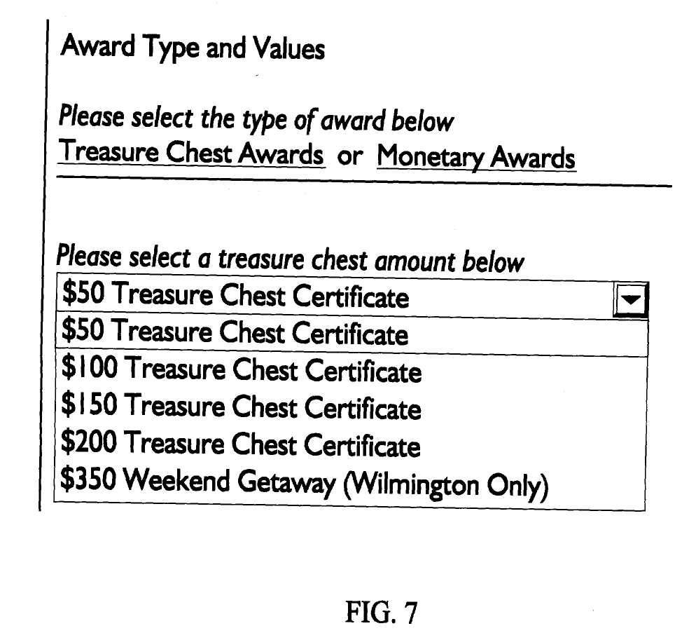

If the award is to be processed, the manager selects the type of Award. In the example system, there are two award categories, namely, a Treasure Chest Certificate award and Monetary award. The Treasure Chest Certificate award includes gift certificates in increments of $50 up to $200 or a weekend getaway valued at $350, as shown in FIG. 7. The manager then selects the administrator or location where the nominee can pick up the certificate, as shown in FIG. 8. When the selections have been made, the manager selects the “Approved Finished” button at the bottom of the screen.

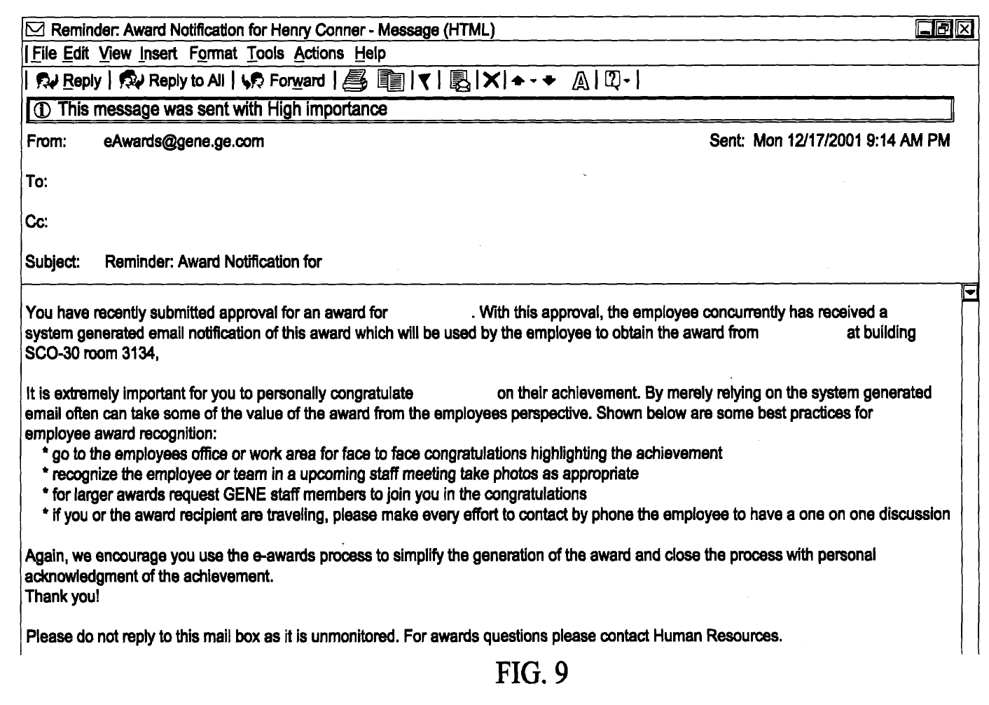

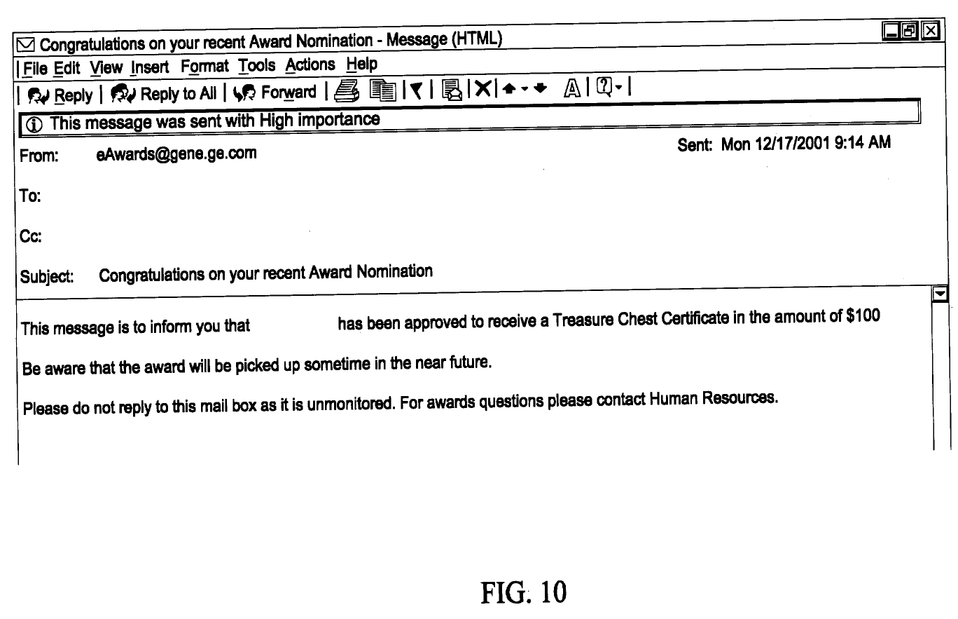

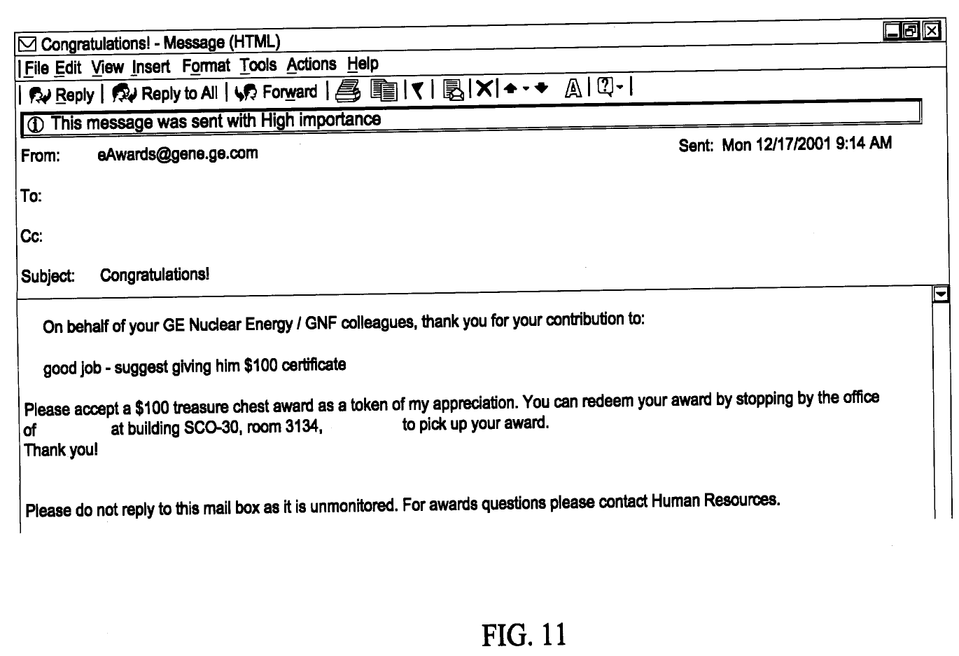

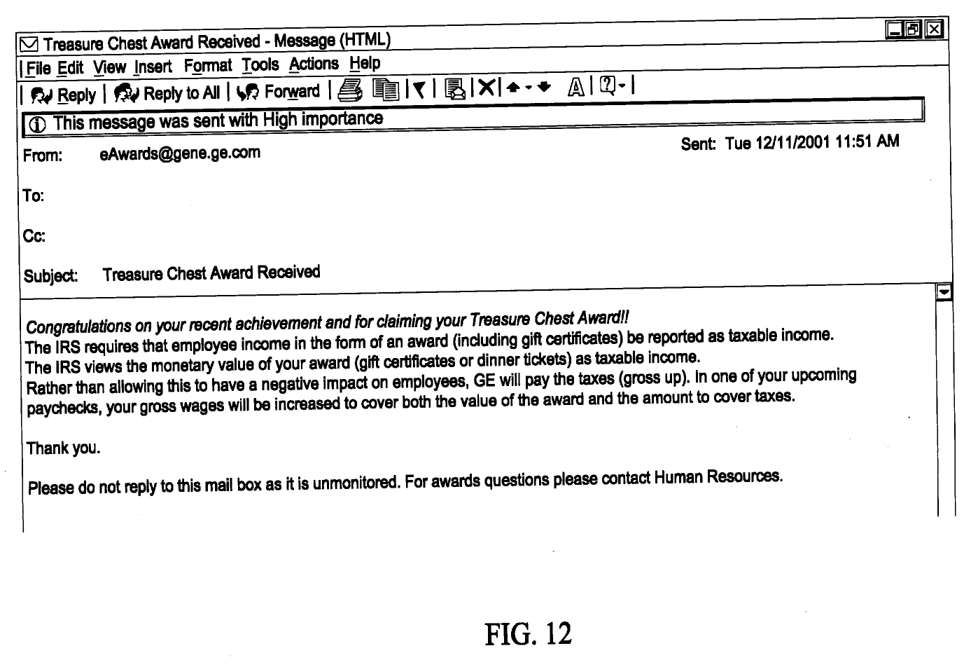

Upon submission, and for Treasure Chest awards, three notification emails are generated. Specifically, an email (FIG. 9) is sent to the manager that approved the award. This email is to remind the manager to personally congratulate the employee on their achievement. Another email is sent to the selected treasure chest administrator (FIG. 10) providing notification of the award pickup. An email (FIG. 11) also is sent to the nominee receiving the award providing notification of the award. The reason for the award from the nomination and approval screens is included in this email. Once the employee actually picks up the gift certificate from the administrator, a final email (FIG. 12) is automatically distributed to the employee.

The last process step is transparent to the users and managers. This step creates the payroll information for the update to the employee wages. Information for payroll is automatically transferred, e.g., weekly, to the business' payroll system for updating the employee wages. Once the transfer is complete, the employee's pay stub reflects the gift certificate earnings and provides a notification to the employee of the update.

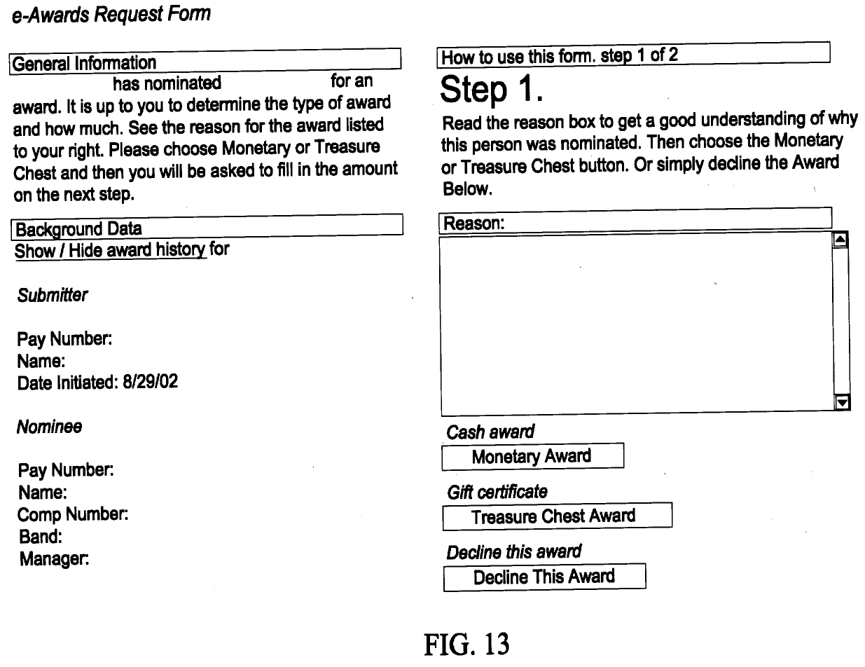

Referring now to FIG. 13, for monetary awards, and after selecting Monetary Awards, the manager selects the type of award rom a drop down list. This selection determines whether this award will be gross or net.

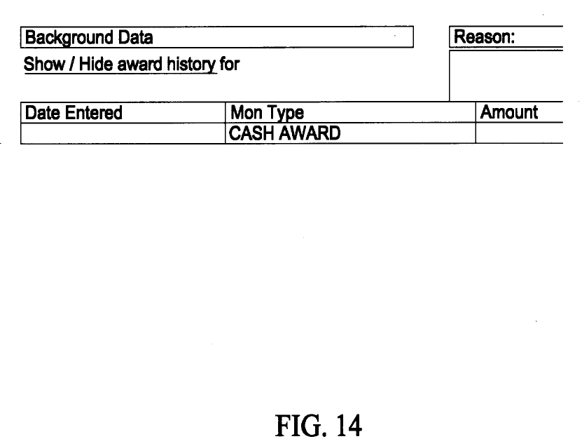

Award History on a nominee is viewable by a link on the left side of the screen. As shown in FIG. 14, the history includes previous monetary award payments. The history, however, does not include previous treasure chest gift certificates. The history can be viewed or hidden by selecting the Show or Hide text on the screen (FIG. 13).

Next, the award amount is entered. In the example system, the following approvals are required for respective award values. The system automatically generates and forwards emails requesting such approvals.

If the award is monetary and below $1000

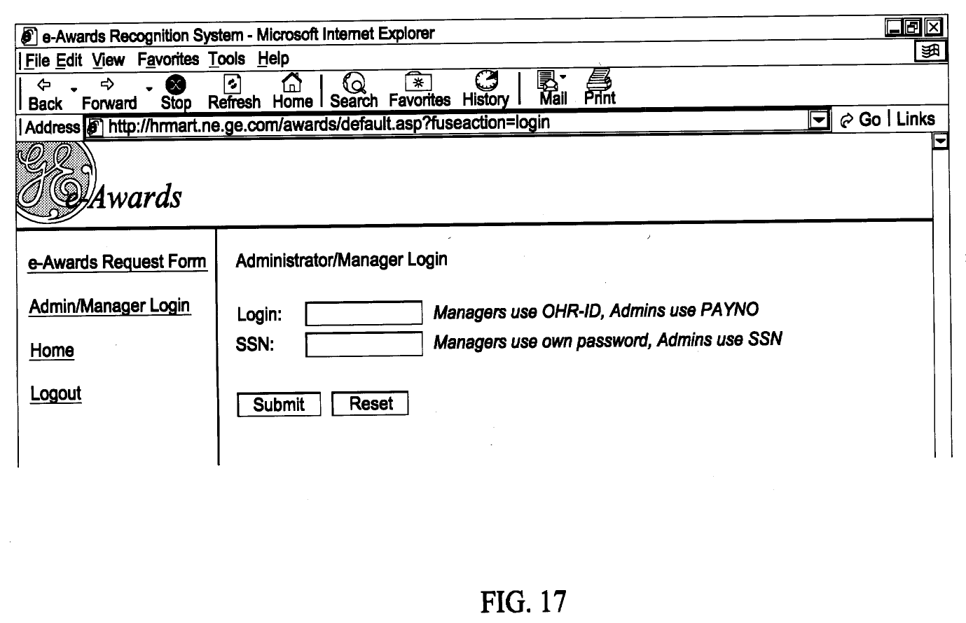

1. An email is sent to the manager that approved the award (FIG. 17).

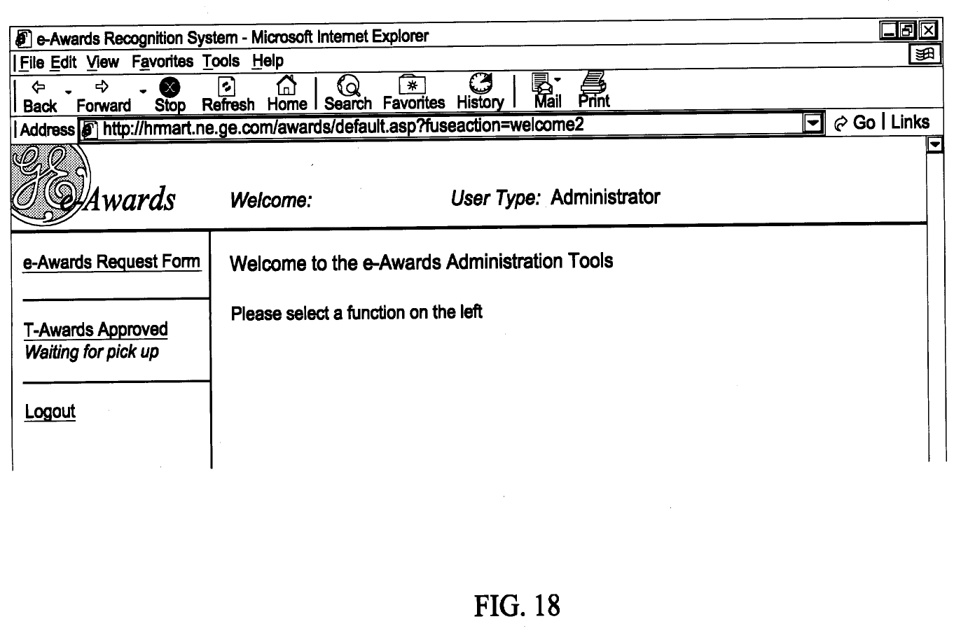

2. An email is sent to the nominee receiving the award (FIG. 18).

If the award is monetary and between $1000 and $2999

1. An email is sent to the manager that approved the award indicating it will be forwarded on for further approval.

2. An email is sent with a link to the general-manager for approval.

If the award is monetary and between $3000 and $3999

1. An email is sent to the department manager that approved the award indicating it will be forwarded on for further approval.

2. An email is sent with a link to the human relations manager for approval.

If the award is monetary and is $4000 or greater

1. An email is sent to back human relations manager indicating that the request will be forwarded on for further approval.

2. An email is sent with a link to president for approval.

Award amounts can be changed as they move through the approval process, as described above. If the award is approved and amount is not changed, an email is sent to the manager that approved the award. An email also is sent to the nominee receiving the award.

If the award is approved and amount is changed, an email is sent to the manager that approved the award. An email also is sent to the original approving manager to make notification of the change, with a final email sent to the nominee receiving the award.

With respect to administrators (admins), such admins can log into the system using their payroll number and social security number (FIG. 17). The administrators can submit nominations and view approved Treasure Chest Awards waiting for pickup from the designated Treasure Chest Administrator (FIG. 18).

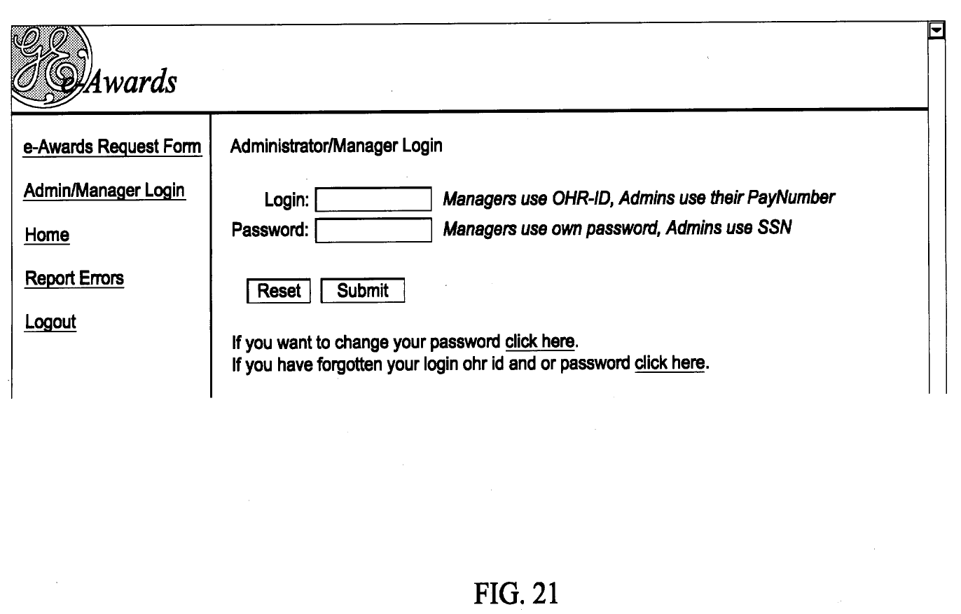

To view and process approved Treasure Chest Awards waiting for pickup, admins select T-Awards Approved (as shown in FIG. 21). Approved Treasure Chest Awards waiting for pick up from the designated TC admin will be displayed. Upon make distribution of the TC award certification, the TC admin will selects Picked Up and then selects “submit”.

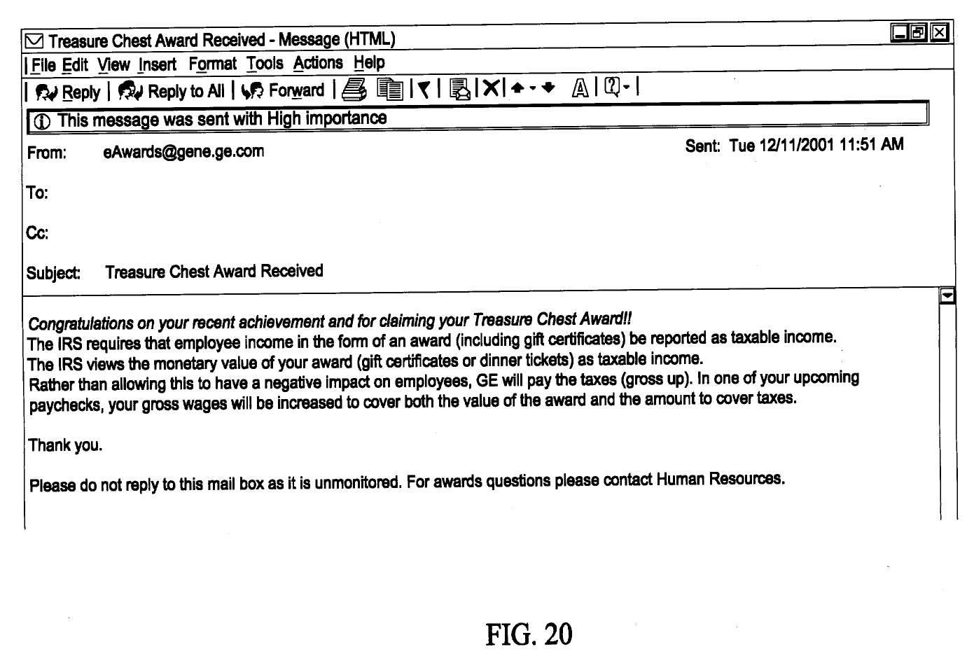

Upon submitting, the employee receives an email notification of award receipt (FIG. 20). The award information is then transferred electronically to the file that makes the necessary payroll updates in the upcoming payroll run.

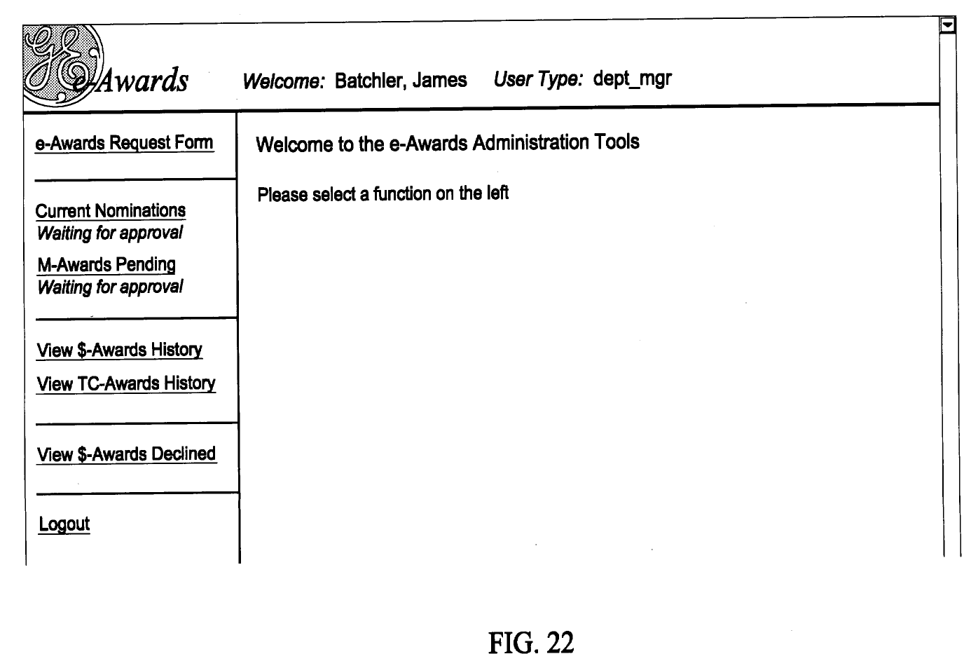

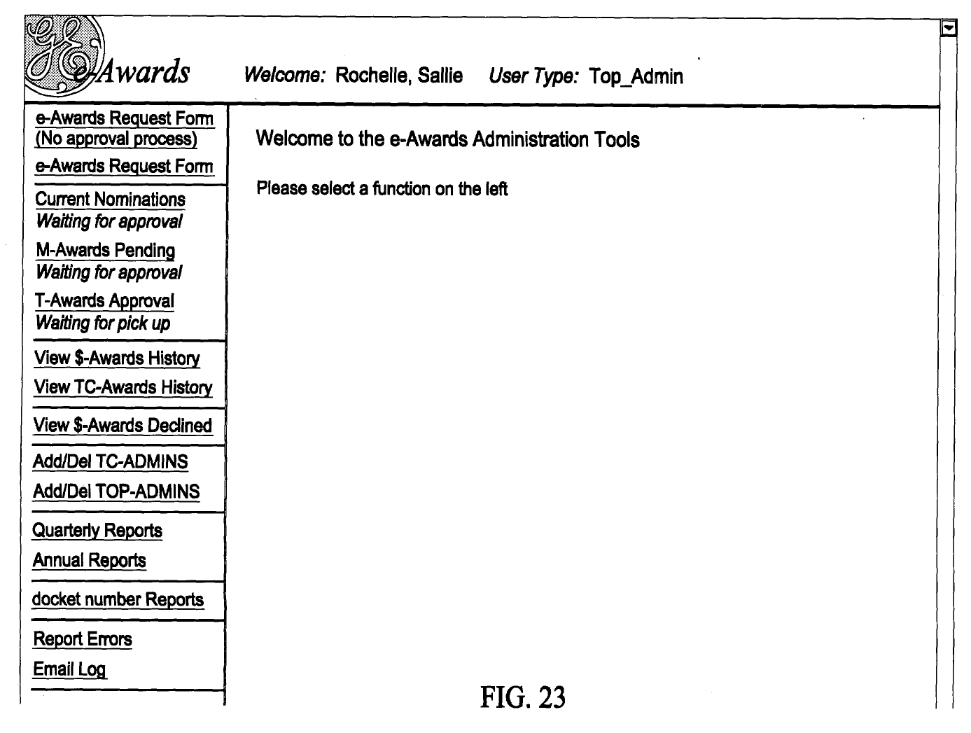

Managers use their human relations identifier as their login and their own unique password (FIG. 21). If they have not already selected one then their current password is the same as their identifier. Managers have the ability to view information for their respective employees only (FIG. 22). As shown in FIG. 23 a top administrator has the ability to view more awards data than a manager.

While the invention has been described in terms of various specific embodiments, those skilled in the art will recognize that the invention can be practiced with modification within the spirit and scope of the claims.

What is claimed is:

1. An employee awards system, comprising:
a database, a plurality of active server pages stored in said database, said active server pages comprising at least one of an awards request form, said awards request form comprising a field for entry of a reason for an employee award and a recommended award amount; and
a server coupled to said database, said server programmed to process data and selections made via said active server pages, said server further programmed to generate at least two e-mails upon submission of said awards request form, a first of said e-mails generated being directed to a nominator of an award and a second of said e-mails generated being directed to a manager of a nominee of an award.

2. An employee award system according to claim 1 wherein if the nominee has a salary above a predetermined salary band level, said server does not process the award to a point at which the requested award is granted.

3. An employee award system according to claim 1 where said second e-mail comprises a link to an award nomination page.

4. An employee award system according to claim 3 wherein said award nomination page comprises a reason for the award, said reason being editable by the manager.

5. An employee award system according to claim 3 wherein the manager can decline the award.

6. An employee award system according to claim 3 wherein the manager, via said award nomination page, selects an award type and a person or location at which the award can be received.

7. An employee award system according to claim 6 wherein upon submission of said award nomination page by the manager, at least three e-mails are generated by said server, a first of said e-mails being generated for the manager that approved the award, a second of said e-mails being generated for a selected administrator, and a third of said e-mails being generated for the nominee receiving the award.

8. An employee award system according to claim 7 further comprising an e-mail generated by said server and comprising payroll information for an update to employee wages of the nominee.

9. An employee award system according to claim 1 further comprising an award history page.

10. An employee award system according to claim 1 wherein said server is programmed to generate e-mails based on predetermined amounts of recommended awards.

11. An employee award system according to claim 10 wherein if the award has a value below a predetermined dollar amount, then an e-mail is generated for the manager that approved the award and an e-mail is generated for the award nominee.

12. An employee award system according to claim 10 wherein if the award has a value above a predetermined dollar amount, then an e-mail is generated for the manager that approved the award and indicating that the award request will be forwarded for further approvals.

13. An employee award system according to claim 1 wherein if a recommended award amount is changed after initial submission by the nominator and approval by an initial approving manger, then said server generates an e-mail for the initial approving manager notifying the manager of a change in the award amount.

14. An employee award system according to claim 1 wherein said server generates at least one table listing at least one of a list of approved awards, a list of awards waiting for pickup.

15. A method for operating a computer to nominate a person for an award, the computer programmed to display a plurality of active server pages, said method comprising the steps of operating the computer to:
display a plurality of active server pages, at least one of said active server pages comprising an awards request form, said awards request form comprising a field for entry of a reason for an employee award and a recommended award amount; and
process data and selections made via said active server pages, said processing comprising generating at least two e-mails upon submission of said awards request form, a first of said e-mails generated being directed to a nominator of an award and a second of said e-mails generated being directed to a manager of a nominee of an award.

16. A method according to claim 15 wherein said second e-mail comprises a link to an award nomination page, and said award nomination page comprises a reason for the award, said reason being editable by the manager.

17. A method according to claim 15 wherein upon submission of said award nomination page by the manager, said processing further comprises generation of at least three e-mails, a first of said e-mails being generated for the manager that approved the award, a second of said e-mails being generated for a selected administrator, and a third of said e-mails being generated for the nominee receiving the award.

18. A method according to claim 17 wherein said processing further comprises generating an e-mail comprising payroll information for an update to employee wages of the nominee.

19. A method according to claim 15 wherein said processing further comprises generating e-mails based on a value of the recommended award, and wherein if the award has a value below a predetermined dollar amount, then an e-mail is generated for the manager that approved the award and an e-mail is generated for the award nominee.

20. A method according to claim 19 wherein if the award has a value above a predetermined dollar amount, then an e-mail is generated for the manager that approved the award and indicating that the award request will be forwarded for further approvals.
